(19) United States
(12) Patent Application Publication
(10) Pub. No.: US 2017/0310718 A1
(43) Pub. Date: Oct. 26, 2017

(54) METHOD AND APPARATUS FOR PROVIDING SERVICE CONTINUITY IN MBSFN SERVICE BOUNDARY AREA

(71) Applicant: LG Electronics Inc., Seoul (KR)

(72) Inventors: Sangwon Kim, Seoul (KR); Youngdae Lee, Seoul (KR)

(21) Appl. No.: 15/518,134

(22) PCT Filed: Oct. 15, 2015
(86) PCT No.: PCT/KR2015/010929

§ 371 Date: Apr. 10, 2017

Related U.S. Application Data
(60) Provisional application No. 62/069,289, filed on Oct. 27, 2014.

(51) Int. Cl. H04L 29/06; H04L 12/18; H04W 4/06; H04W 36/00; H04W 48/12; H04H 20/71; H04W 36/08; H04W 48/16; H04W 48/20; H04W 76/00

(52) U.S. Cl. CPC H04L 65/4076; H04L 12/18; H04L 12/189; H04W 4/06; H04W 36/0033; H04W 48/12; H04H 20/71; H04W 36/0055; H04W 36/08; H04W 48/16; H04W 48/20; H04W 76/002; H04W 36/0083

(57) ABSTRACT

The present specification provides a method and an apparatus for a terminal to maintain continuity of multimedia broadcast multicast service (MBMS) service in a multicast broadcast single frequency network (MBSFN) service boundary area. The terminal receives, from a first cell, an MBMS cell list including information about an MBSFN area. The first cell is a cell where the terminal provides the MBMS service via an MBMS bearer. The terminal performs the MBMS service via a unicast bearer of a second cell on the basis of the received MBMS cell list.

### CROSS-REFERENCE TO RELATED APPLICATIONS

This application is the National Stage filing under 35 U.S.C. 371 of International Application No. PCT/KR2015/010929, filed on Oct. 15, 2015, which claims the benefit of U.S. Provisional Application No. 62/069,289 filed Oct. 27, 2014, the contents of which are all hereby incorporated by reference herein in their entirety.

### BACKGROUND OF THE INVENTION

### Field of the Invention

The present invention relates to mobile communication, and more particularly to a method and an apparatus for providing continuity of a Multimedia Broadcast/Multicast Service (MBMS) service in a multicast/broadcast single frequency network (MBSFN) service boundary area.

### Related Art

A handover refers to a function enabling a moving user equipment (UE), which is moving out of a current communication service area and is entering an adjacent communication service area, to be automatically tuned to a new traffic channel in the adjacent communication service area to maintain an ongoing call. That is, the UE communicating with a specific base station (BS) is linked to another adjacent BS when the strength of a signal from the specific BS becomes weak. When the handover is achieved, call disconnection caused by the movement of the UE to an adjacent cell may be resolved.

A Multimedia Broadcast/Multicast Service (MBMS) is a service of simultaneously transmitting a data packet to a plurality of users, similar to an existing Cell Broadcast Service (CBS). However, the CBS is a low-speed message-based service, while the MBMS is designed for high-speed multimedia data transmission. Further, the CBS is not Internet Protocol (IP)-based, whereas the MBMS is based on IP multicast. According to the MBMS, when users of a certain level are present in the same cell, the users are allowed to receive the same multimedia data using a shared resource (or channel), and thus the efficiency of radio resources may be improved and the users may use a multimedia service at low costs.

The MBMS uses a shared channel so that a plurality of UEs efficiently receives data on one service. A BS allocates only one shared channel for data on one service, instead of allocating as many dedicated channels as the number of UEs to receive the service in one cell. The plurality of UEs simultaneously receives the shared channel, thus improving the efficiency of radio resources. Regarding the MBMS, a UE may receive the MBMS after receiving system information on the cell.

### SUMMARY OF THE INVENTION

The present invention proposes a method and a device for maintaining continuity of a Multimedia Broadcast/Multicast Service (MBMS) service in a multicast/broadcast single frequency network (MBSFN) service boundary area. A user equipment (UE) may receive an MBMS cell list including information on an MBSFN area from a cell providing an MBMS service through a current MBMS bearer, and may continuously perform the MBMS service with UEs through a unicast bearer based on the received MBMS cell list although moving to a neighboring cell. The MBMS cell list may be signaled by the MBSFN area, the service area, the service, or the frequency.

According to one embodiment, there is provided a method for a UE to maintain continuity of an MBMS service in an MBSFN service boundary area.

The method may include: receiving, from a first cell, an MBMS cell list including information on a cell providing the MBMS service; and performing the MBMS service via a unicast bearer of a second cell based on the received the MBMS cell list, if the second cell does not provide the MBMS service.

The first cell may be a cell in which the UE performs the MBMS service via an MBMS bearer.

The MBMS cell list may be signaled per MBSFN area, service area, service, or frequency.

The MBMS cell list may be received through at least one of system information, a user service description (USD), and dedicated signaling.

The second cell may have a different MBSFN area providing the MBMS service than the first cell.

The MBMS cell list may further include frequency information on the cell providing the MBMS service, and a frequency of the second cell may not be included in the MBMS cell list.

An identity (ID) of the second cell may not be included in the MBMS cell list.

The method may further include receiving a handover command message from the first cell, performing a handover to the second cell, and requesting unicast transmission from a network, when the UE is in an RRC connected state and moves to the second cell.

The second cell may be a cell triggering a measurement report.

The method may further include selecting the second cell as a new serving cell and requesting configuration of the unicast bearer from the second cell, when the UE is an RRC idle state.

The method may further include requesting an RRC connection from the second cell.

A quality measurement result of the second cell may be a predetermined threshold or higher.

The configuration of the unicast bearer may be an NAS message or RRC message.

According to another embodiment, there is provided a UE for maintaining continuity of a Multimedia Broadcast/Multicast Service (MBMS) service in a multicast/broadcast single frequency network (MBSFN) service boundary area.

The UE may include: a memory; a transceiver; and a processor to connect the memory and the transceiver, wherein the processor may be configured to: control the transceiver to receive, from a first cell, an MBMS cell list comprising information on a cell providing the MBMS service; and perform the MBMS service via a unicast bearer of a second cell based on the received the MBMS cell list, if the second cell does not provide the MBMS service, and the first cell may be a cell in which the UE performs the MBMS service via an MBMS bearer.

An identity (ID) of the second cell may not be included in the MBMS cell list.

The present invention may minimize delay time of an MBMS service caused by the movement of a UE from an MBSFN area, where the UE is currently receiving the MBMS service, to a different MBSFN are or a non-MBSFN area.

### BRIEF DESCRIPTION OF THE DRAWINGS

FIG. 1 shows a wireless communication system to which the present invention is applied.

FIG. 2 shows a core network architecture of an MBMS more specifically to which the present invention applies.

FIG. 3 is a user plane structure for supporting an MBMS.

FIG. 4 is a control plane structure for supporting an MBMS.

FIG. 5 illustrates a structure of an MBSFN subframe.

FIG. 6 illustrates an example in which a UE moves from an MBSFN area to a different MBSFN area or a non-MBSFN area.

FIG. 7 illustrates an example of a UE operation in RRC_CONNECTED MODE according to one embodiment of the present invention.

FIG. 8 illustrates an example of a UE operation in RRC_IDLE MODE according to one embodiment of the present invention.

FIG. 9 is a block diagram illustrating a method for maintaining continuity of an MBMS service in an MBSFN service boundary area according to one embodiment of the present invention.

FIG. 10 is a block diagram illustrating a wireless communication system according to one embodiment of the present invention.

### DESCRIPTION OF EXEMPLARY EMBODIMENTS

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802.20, evolved UTRA (E-UTRA), etc. IEEE 802.16m is evolved from IEEE 802.16e, and provides backward compatibility with a system based on the IEEE 802.16e. The UTRA is a part of a universal mobile telecommunication system (UMTS). 3rd generation partnership project (3GPP) long term evolution (LTE) is a part of an evolved UMTS (E-UMTS) using the E-UTRA. The 3GPP LTE uses the OFDMA in a downlink and uses the SC-FDMA in an uplink. LTE-advanced (LTE-A) is an evolution of the LTE.

For clarity, the following description will focus on LTE-A. However, technical features of the present invention are not limited thereto.

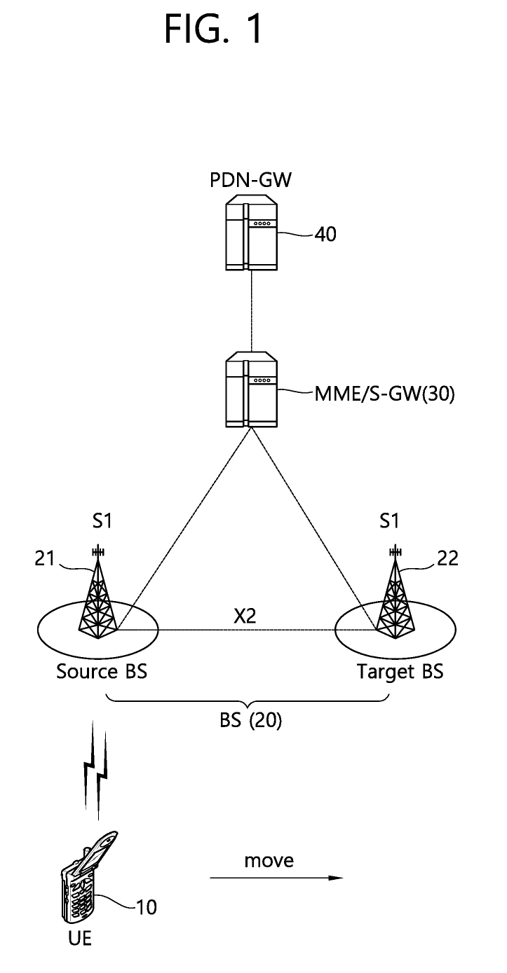

FIG. 1 shows a wireless communication system to which the present invention is applied. The wireless communication system may also be referred to as an evolved-UMTS terrestrial radio access network (E-UTRAN) or a long term evolution (LTE)/LTE-A system.

Referring to FIG. 1, the E-UTRAN includes at least one base station (BS) 20 that provides a user equipment (UE) with a control plane and a user plane. The UE 10 may be stationary or mobile, and may be referred to by other terms, such as an MS (Mobile Station), an AMS (Advanced MS), a UT (User Terminal), an SS (Subscriber Station), or a wireless device.

The base station 20 generally refers to a station that communicates with the UE 10, and may be referred to by other terms such as an eNodeB (Evolved-NodeB), a BTS (Base Transceiver System), an access point, a femto-eNB, a pico-eNB, a home eNB, or a relay. The base station 20 may provide at least one cell to the UE. The cell may mean a geographical area to in which a communication service is offered or a specific frequency band. The cell may mean a downlink frequency resource and an uplink frequency resource. Or, the cell may mean a combination of a downlink frequency resource and an optional uplink frequency resource. Further, in general case carrier aggregation (CA) is not considered, one cell has a pair of uplink and downlink frequency resources.

An interface for transmission of user traffic or control traffic may be used between base stations 20. The source base station (BS) 21 refers to a base station having a radio bearer currently established with the UE 10, and the target base station (BS) 22 refers to a base station to which the UE 10 is to hand over, disconnecting the radio bearer with the source base station 21.

The base stations 20 may be linked to each other via an X2 interface that is used for exchanging messages between the base stations 20. The base station 20 is linked through an S1 interface to an EPS (Evolved Packet System), more specifically, a mobility management entity (hereinafter, MME)/S-GW (Serving Gateway, 30). The S1 interface supports a many-to-many relation between the base station 20 and the MME/S-GW 30. In order to provide a packet data service to the MME/S-GW 30, a PDN-GW 40 is used. The PDN-GW 40 varies depending on the purpose or service of communication, and a PDN-GW 40 for supporting a specific service can be discovered using APN (Access Point Name) information.

The inter E-UTRAN handover is a basic handover mechanism used for handover between E-UTRAN access networks and consists of X2-based handover and S1-based handover. The X2-based handover is used when the UE hands over from the source BS 21 to the target BS 22 using an X2 interface, and at this time, the MME/S-GW 30 is not changed. By the S1-based handover, the first bearer that has been established between the P-GW 40, MME/S-GW 30, source BS 21, and UE 10 is released, and a new second bearer is established between the P-GW 40, MME/S-GW 30, target BS 22, and UE 10.

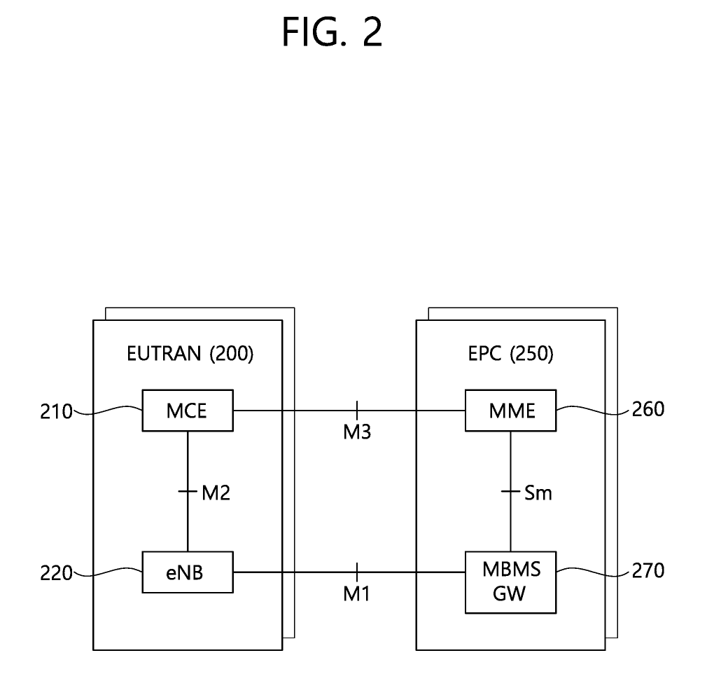

FIG. 2 shows more specifically a core network architecture of an MBMS to which the present invention applies.

Referring to FIG. 2, the radio access network (EUTRAN, 200) includes a multi-cell coordination entity (hereinafter, “MCE”, 210) and a base station (eNB, 220). The MCE 210 is a main entity for controlling the MBMS and plays a role to perform session management, radio resource allocation or admission control of the base station 220. The MCE 210 may be implemented in the base station 220 or may be implemented independent from the base station 220. The interface between the MCE 210 and the base station 220 is called M2 interface. The M2 interface is an internal control plane interface of the radio access network 200 and MBMS control information is transmitted through the M2 interface. In case the MCE 210 is implemented in the base station 220, the M2 interface may be present only logically.

The EPC (Evolved Packet Core, 250) includes an MME 260 and an MBMS gateway (GW) 270. The MME 260 performs such operations as NAS signaling, roaming, authentication, selection of a PDN gateway and the S-GW, MME selection for handover by an MME change, accessibility to an idle mode UE, or AS security control.

The MBMS gateway 270 is an entity for transmitting MBMS service data and is positioned between the base station 220 and the BM-SC and performs MBMS packet transmission and broadcast to the base station 220. The MBMS gateway 270 uses a PDCP and IP multicast to transmit user data to the base station 220 and performs session control signaling for the radio access network 200.

The interface between the MME 260 and the MCE 210 is a control plane interface between the radio access network 200 and the EPC 250 and is called M3 interface. Control information related to MBMS session control is transmitted through the M3 interface. The MME 260 and the MCE 210 transmits, to the base station 220, session control signaling such as a session start/stop message for session start or session stop, and the base station 220 may inform the UE through a cell notification that the corresponding MBMS service has been started or stopped.

The interface between the base station 220 and the MBMS gateway 270 is a user plane interface and is called M1 interface.

Through the M2 interface, MBMS service data is transmitted. Meanwhile, in case a UE switches cells due to relocation while receiving an MBMS service, the reception of the MBMS service might not be continuously done. If the UE keeps performing the decoding operation in order to receive the MBMS service in such case, its battery may be wasted. A need exists for a scheme that allows a UE using an MBMS service to continuously receive the MBMS service upon handover without resource waste.

The source cell means a cell where a UE is currently receiving a service. The base station offering the source cell is referred to as source base station. The neighbor cell means a cell that is positioned adjacent to the source cell geographically or in a frequency band. The neighbor cell having the same carrier frequency as the source cell is referred to as intra-frequency neighbor cell, and the neighbor cell having a different carrier frequency from the source cell is referred to as inter-frequency neighbor cell. In other words, cells that use different frequencies from the source cell and are positioned adjacent to the source cell, as well as cells using the same frequency as the source cell, may be all called neighbor cells.

When a UE hands over from a source cell to an intra frequency neighbor cell, to such handover is called intra-frequency handover. On the other hand, a UE's handover from a source cell to an inter-frequency neighbor cell is called inter-frequency handover. The neighbor cell to which, upon handover, a UE goes over, is referred to as a target cell. The base station providing a target cell is called a target base station.

A source cell and a target cell may be provided by one base station or by different base stations from each other. Hereinafter, for ease of description, the source cell and the target cell are assumed to be provided by different base stations from each other, i.e., a source base station and a target base station. Accordingly, the source base station and the source cell may be used interchangeably, while the target base station and the target cell may be used interchangeably.

The MBMS service may be subjected to cell-based or geography-based management or localization. The MBMS service area is the term for denoting an area where a specific MBMS service is offered. For example, when the area where a specific MBMS service A is on is called MBMS service area A, the network may be left in the state of being transmitting MBMS service A. At this time, a UE may receive MBMS service A depending on the UE's capability. The MBMS service area may be defined in the point of view of service and application on whether a specific service is provided in a predetermined region.

The RRC state of UE and an RRC connection method are described below.

The RRC state means whether or not the RRC layer of UE is logically connected to the RRC layer of the E-UTRAN. A case where the RRC layer of UE is logically connected to the RRC layer of the E-UTRAN is referred to as an RRC connected state. A case where the RRC layer of UE is not logically connected to the RRC layer of the E-UTRAN is referred to as an RRC idle state. The E-UTRAN may check the existence of corresponding UE in the RRC connected state in each cell because the UE has RRC connection, so the UE may be effectively controlled. In contrast, the E-UTRAN is unable to check UE in the RRC idle state, and a Core Network (CN) manages UE in the RRC idle state in each tracking area, that is, the unit of an area greater than a cell. That is, the existence or non-existence of UE in the RRC idle state is checked only for each large area. Accordingly, the UE needs to shift to the RRC connected state in order to be provided with common mobile communication service, such as voice or data.

When a user first powers UE, the UE first searches for a proper cell and remains in the RRC idle state in the corresponding cell. The UE in the RRC idle state establishes RRC connection with an E-UTRAN through an RRC connection procedure when it is necessary to set up the RRC connection, and shifts to the RRC connected state. A case where UE in the RRC idle state needs to set up RRC connection includes several cases. For example, the cases may include a need to send uplink data for a reason, such as a call attempt by a user, and to send a response message as a response to a paging message received from an E-UTRAN.

A Non-Access Stratum (NAS) layer placed over the RRC layer performs functions, such as session management and mobility management.

In the NAS layer, in order to manage the mobility of UE, two types of states: EPS Mobility Management-REGISTERED (EMM-REGISTERED) and EMM-DEREGISTERED are defined. The two states are applied to UE and the MME. UE is initially in the EMM-DEREGISTERED state. In order to access a network, the UE performs a process of registering it with the corresponding network through an initial attach procedure. If the attach procedure is successfully performed, the UE and the MME become the EMM-REGISTERED state.

In order to manage signaling connection between UE and the EPC, two types of states: an EPS Connection Management (ECM)-IDLE state and an ECM-CONNECTED state are defined. The two states are applied to UE and the MME. When the UE in the ECM-IDLE state establishes RRC connection with the E-UTRAN, the UE becomes the ECM-CONNECTED state. The MME in the ECM-IDLE state becomes the ECM-CONNECTED state when it establishes S1 connection with the E-UTRAN. When the UE is in the ECM-IDLE state, the E-UTRAN does not have information about the context of the UE. Accordingly, the UE in the ECM-IDLE state performs procedures related to UE-based mobility, such as cell selection or cell reselection, without a need to receive a command from a network. In contrast, when the UE is in the ECM-CONNECTED state, the mobility of the UE is managed in response to a command from a network. If the location of the UE in the ECM-IDLE state is different from a location known to the network, the UE informs the network of its corresponding location through a tracking area update procedure.

A detailed description of a procedure of selecting a cell, by a UE, is described below.

When power is turned-on or the UE is located in a cell, the UE performs procedures for receiving a service by selecting/reselecting a suitable quality cell.

A UE in an RRC idle state should prepare to receive a service through the cell by always selecting a suitable quality cell. For example, a UE where power is turned-on just before should select the suitable quality cell to be registered in a network. If the UE in an RRC connection state enters in an RRC idle state, the UE should selects a cell for stay in the RRC idle state. In this way, a procedure of selecting a cell satisfying a certain condition by the UE in order to be in a service idle state such as the RRC idle state refers to cell selection. Since the cell selection is performed in a state that a cell in the RRC idle state is not currently determined, it is important to select the cell as rapid as possible. Accordingly, if the cell provides a wireless signal quality of a predetermined level or greater, although the cell does not provide the best wireless signal quality, the cell may be selected during a cell selection procedure of the UE.

A method and a procedure of selecting a cell by a UE in a 3GPP LTE is described with reference to 3GPP TS 36.304 V8.5.0 (2009-03) “User Equipment (UE) procedures in idle mode (Release 8)”.

A cell selection process is basically divided into two types.

The first is an initial cell selection process. In this process, UE does not have preliminary information about a wireless channel. Accordingly, the UE searches for all wireless channels in order to find out a proper cell. The UE searches for the strongest cell in each channel thereafter, if the UE has only to search for a suitable cell that satisfies a cell selection criterion, the UE selects the corresponding cell.

Next, the UE may select the cell using stored information or using information broadcasted by the cell. Accordingly, cell selection may be fast compared to an initial cell selection process. If the UE has only to search for a cell that satisfies the cell selection criterion, the UE selects the corresponding cell. If a suitable cell that satisfies the cell selection criterion is not retrieved though such a process, the UE performs an initial cell selection process.

After the UE selects a specific cell through the cell selection process, the intensity or quality of a signal between the UE and a BS may be changed due to a change in the mobility or wireless environment of the UE. Accordingly, if the quality of the selected cell is deteriorated, the UE may select another cell that provides better quality. If a cell is reselected as described above, the UE selects a cell that provides better signal quality than the currently selected cell. Such a process is called cell reselection. In general, a basic object of the cell reselection process is to select a cell that provides UE with the best quality from a viewpoint of the quality of a radio signal.

In addition to the viewpoint of the quality of a radio signal, a network may determine priority corresponding to each frequency, and may inform the UE of the determined priorities. The UE that has received the priorities preferentially takes into consideration the priorities in a cell reselection process compared to a radio signal quality criterion.

As described above, there is a method of selecting or reselecting a cell according to the signal characteristics of a wireless environment. In selecting a cell for reselection when a cell is reselected, the following cell reselection methods may be present according to the RAT and frequency characteristics of the cell.
Intra-frequency cell reselection: UE reselects a cell having the same center frequency as that of RAT, such as a cell on which the UE camps on.
Inter-frequency cell reselection: UE reselects a cell having a different center frequency from that of RAT, such as a cell on which the UE camps on
Inter-RAT cell reselection: UE reselects a cell that uses RAT different from RAT on which the UE camps

The principle of a cell reselection process is as follows.

First, UE measures the quality of a serving cell and neighbor cells for cell reselection.

Second, cell reselection is performed based on a cell reselection criterion. The cell reselection criterion has the following characteristics in relation to the measurements of a serving cell and neighbor cells.

Intra-frequency cell reselection is basically based on ranking. Ranking is a task for defining a criterion value for evaluating cell reselection and numbering cells using criterion values according to the size of the criterion values. A cell having the best criterion is commonly called the best-ranked cell. The cell criterion value is based on the value of a corresponding cell measured by UE, and may be a value to which a frequency offset or cell offset has been applied, if necessary.

Inter-frequency cell reselection is based on frequency priority provided by a network. UE attempts to camp on a frequency having the highest frequency priority. A network may provide frequency priority that will be applied by UEs within a cell in common through broadcasting signaling, or may provide frequency-specific priority to each UE through UE-dedicated signaling. A cell reselection priority provided through broadcast signaling may refer to a common priority. A cell reselection priority for each terminal set by a network may refer to a dedicated priority. If receiving the dedicated priority, the terminal may receive a valid time associated with the dedicated priority together. If receiving the dedicated priority, the terminal starts a validity timer set as the received valid time together therewith. While the valid timer is operated, the terminal applies the dedicated priority in the RRC idle mode. If the valid timer is expired, the terminal discards the dedicated priority and again applies the common priority.

For the inter-frequency cell reselection, a network may provide UE with a parameter (e.g., a frequency-specific offset) used in cell reselection for each frequency.

For the intra-frequency cell reselection or the inter-frequency cell reselection, a network may provide UE with a Neighboring Cell List (NCL) used in cell reselection. The NCL includes a cell-specific parameter (e.g., a cell-specific offset) used in cell reselection.

For the intra-frequency or inter-frequency cell reselection, a network may provide UE with a cell reselection black list used in cell reselection. The UE does not perform cell reselection on a cell included in the black list.

Ranking performed in a cell reselection evaluation process is described below.

A ranking criterion used to give the priority of a cell is defined as in Equation 1.

R_{S}=Q_{meas,s}+Q_{hyst},Rₙ=Q_{meas,n}−Q_{offset} [Equation 1]

In Equation 1, Rs is the ranking criterion of a serving cell on which UE now camps, Rn is the ranking criterion of a neighboring cell, Qmeas,s is the quality value of the serving cell measured by the UE, Qmeas,n is the quality value of the neighboring cell measured by the UE, Qhyst is a hysteresis value for ranking, and Qoffset is an offset between the two cells.

In Intra-frequency, if UE receives an offset “Qoffsets,n” between a serving cell and a neighbor cell, Qoffset=Qoffsets,n. If UE does not Qoffsets,n, Qoffset=0.

In Inter-frequency, if UE receives an offset “Qoffsets,n” for a corresponding cell, Qoffset=Qoffsets,n+Qfrequency. If UE does not receive “Qoffsets,n”, Qoffset=Qfrequency.

If the ranking criterion Rs of a serving cell and the ranking criterion Rn of a neighbor cell are changed in a similar state, ranking priority is frequency changed as a result of the change, and UE may alternately reselect the twos. Qhyst is a parameter that gives hysteresis to cell reselection so that UE is prevented from to alternately reselecting two cells.

UE measures RS of a serving cell and Rn of a neighbor cell according to the above equation, considers a cell having the greatest ranking criterion value to be the best-ranked cell, and reselects the cell.

In accordance with the criterion, it may be checked that the quality of a cell is the most important criterion in cell reselection. If a reselected cell is not a suitable cell, UE excludes a corresponding frequency or a corresponding cell from the subject of cell res election.

Hereinafter, an MBMS and a multicast/broadcast single frequency network (MBSFN) are described in detail.

MBSFN transmission or MBSFN-mode transmission refers to a simultaneous transmission scheme in which a plurality of cells transmits the same signal at the same time. MBSFN transmissions from a plurality of cells within an MBSFN area are perceived as a single transmission for a UE.

A multicast channel (MCH) as a transmission channel for an MBMS may be mapped to logical channels, a multicast control channel (MCCH) and a multicast traffic channel (MTCH). The MCCH is used to transmit an MBMS-related RRC message, and the MTCH channel is used to transmit traffic of a certain MBMS service. One MCCH channel is present in each one MBMS single frequency network (MBSFN) area where the same MBMS information/traffic is transmitted. When one cell provides a plurality of MBSFN areas, a UE may receive a plurality of MCCHs. When an MBMS-related RRC message is changed in a specific MCCH, a PDCCH transmits an MBMS radio network temporary identity (M-RNTI) and an indicator indicating the specific MCCH. A UE supporting an MBMS receives the M-RNTI and the MCCH indicator through the PDCCH to identify that the MBMS-related RRC message is changed in the specific MCCH and may receive the specific MCCH. The RRC message of the MCCH may be changed per modification period and is repeatedly broadcast according to a repetition period.

A UE may also be provided with a dedicated service while being provided with an MBMS service. For example, a user may chat on the user's own smartphone using an instant messaging (IM) service, such as MSN or Skype, simultaneously with watching a TV on the smartphone through an MBMS service. In this case, the MBMS service is provided through an MTCH received by a plurality of UEs at the same time, while a service provided for each individual UE, such as the IM service, is provided through a dedicated bearer, such as a dedicated control channel (DCCH) or dedicated traffic channel (DTCH).

In one area, a BS may use a plurality of frequencies at the same time. In this case, in order to efficiently use radio resources, a network may select one of the frequencies to provide an MBMS service only in the frequency and may provide a dedicated bearer for each UE in all frequencies. In this case, when a UE, which has been provided with a service using a dedicated bearer in a frequency where no MBMS service is provided, wishes to be provided with an MBMS service, the UE needs to be handed over to an MBMS providing frequency. To this end, the UE transmits an MBMS interest indication to a BS. That is, when the UE wishes to receive an MBMS service, the UE transmits an MBMS interest indication to the BS. When the BS receives the indication, the BS recognizes that the UE wishes to receive the MBMS service and hands the UE over to an MBMS providing frequency. Here, the MBMS interest indication is information indicating that the UE wishes to receive an MBMS service, which additionally includes information on a frequency to which the UE wishes to be handed over.

The UE, which wishes to receive a specific MBMS service, first identifies information on a frequency at which the specific service is provided and information on broadcast time at which the specific service is provided. When the MBMS service is already on air or is about to be on air, the UE assigns a highest priority to the frequency at which the MBMS service is provided. The UE performs a cell reselection procedure using reset frequency priority information and moves to a cell providing the MBMS service to receive the MBMS service.

When the UE is receiving an MBMS service or is interested in receiving an MBMS service and when the UE is allowed to receive an MBMS service while camping on an MBMS service-providing frequency, it may be considered that the frequency is assigned a highest priority during an MBMS session as long as the following situations last while the reselected cell is broadcasting SIB13.
When SIB15 of a serving cell indicates that one or more MBMS service area identities (SAIs) are included in the user service description (USD) of the service.
SIB15 is not broadcast in a serving cell, and the frequency is included in the USD of the service.

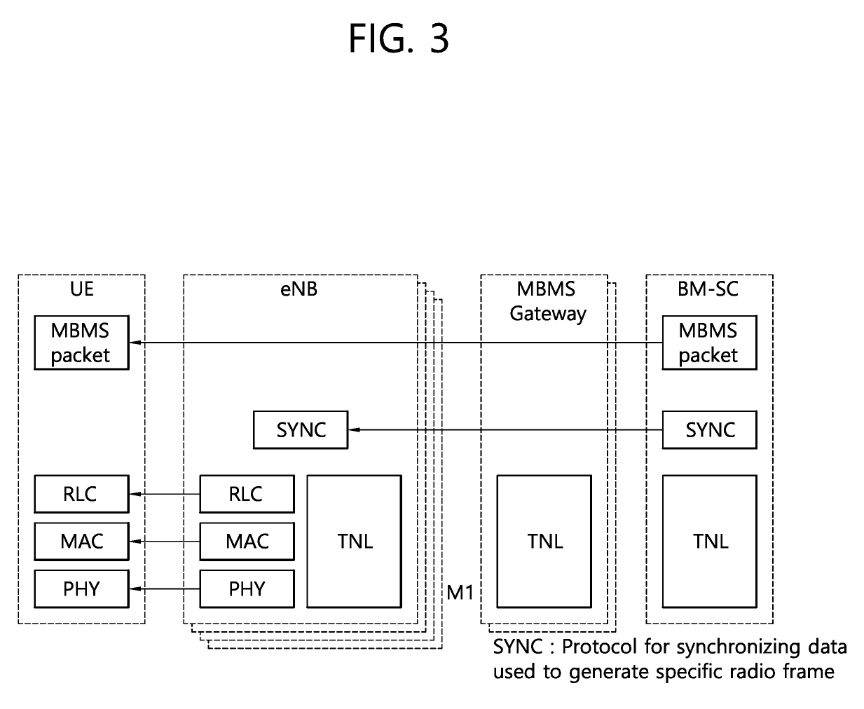

FIG. 3 is a user plane structure for supporting an MBMS.

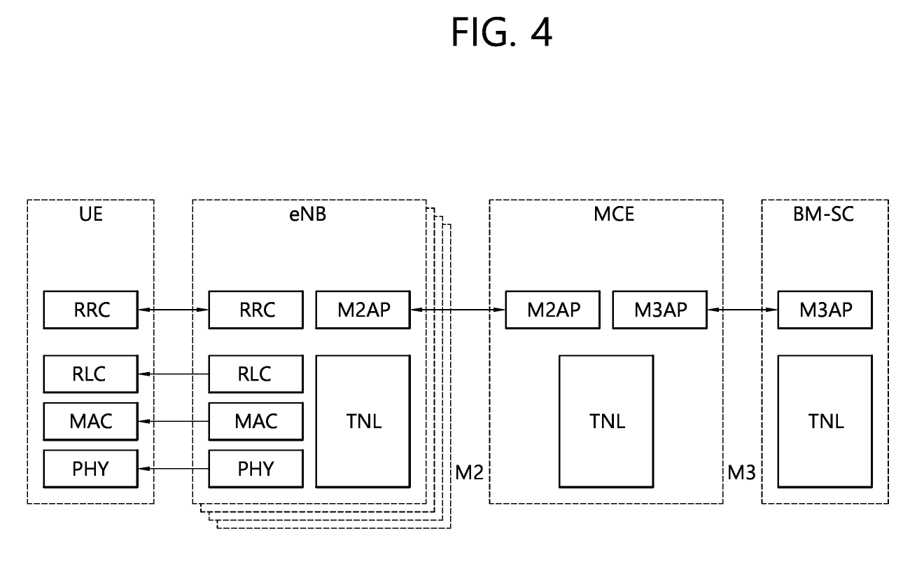

FIG. 4 is a control plane structure for supporting an MBMS.

A UE needs to be able to receive an MBMS in RRC_IDLE and RRC_CONNECTED states.

In the RRC_IDLE state, the UE may operate as follows.

1) UE-specific DRX may be set by an upper layer. 2) The UE monitors a paging channel to detect a call, a system information change, and an ETWS notification and performs adjacent cell measurement and cell selection (reselection). The UE may acquire system information and may perform possible measurement.

In the RRC_CONNECTED state, the UE may transmit unicast data and may set UE-specific DRX in a lower layer. The UE supporting CA may use one or more secondary cells along with a primary cell.

The UE monitors the paging channel and monitors the content of system information block (SIB) type 1 to detect a system information change. To determine whether data is scheduled for the UE, the UE monitors control channels associated with a shared data channel. Further, the UE provides channel quality and feedback information. The UE may measure a neighboring cell, may report a measurement result, and acquires system information.

A multicast control channel (MCCH) as a logic channel for transmitting control information on an MBMS has the following features.

One MBSFN area is associated with one MCCH, and one PCCH corresponds to one MBSFN area. An MCCH is transmitted through a multicast channel (MCH). The MCCH includes one MBSFN area configuration RRC message and has a list of all MBMS services. The MCCH is transmitted in all cells within an MBSFN area excluding an MBSFN area reserved cell. The MCCH is RRC-transmitted every MCCH repetition period. The MCCH uses a modification period. A notification mechanism is used to notify an MCCH change caused by the start of an MCCH session or the presence of an MBMS counting request message. The UE detects an MCCH change, known not by the notification mechanism, through MCCH monitoring in a modification period.

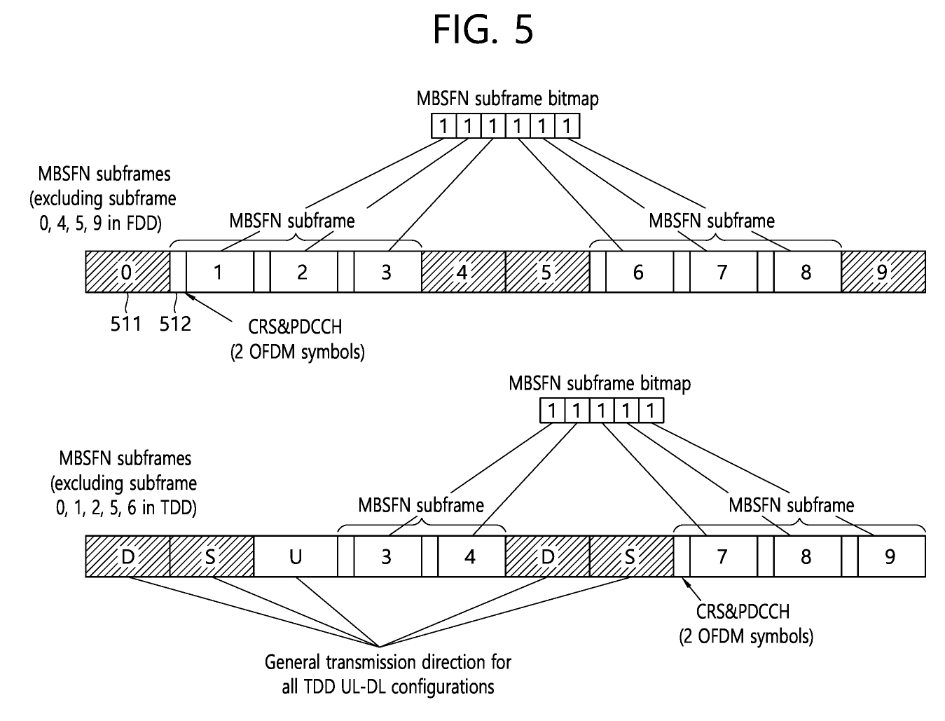

FIG. 5 illustrates a structure of an MBSFN subframe.

Referring to FIG. 5, MBSFN transmission is configured by the subframe. A subframe configured to perform MBSFN transmission is referred to as an MBSFN subframe. In a subframe configured as an MBSFN subframe, MBSFN transmission is performed in OFDM symbols other than first two OFDM symbols for PDCH transmission. For convenience, a region used for MBSFN transmission is defined as an MBSFN region. In the MBSFN region, no CRS for unicast is transmitted but an MBMS-dedicated RS common to all cells participating in transmission is used.

In order to notify even a UE receiving no MBMS that no CRS is transmitted in the MBSFN region, system information on a cell is broadcast including configuration information on the MBSSFN subframe.

Since most UEs perform radio resource management (RRM), radio link failure (RLF) processing, and synchronization using a CRS, it is important to indicate the absence of a CRS in a specific region.

A CRS is transmitted in first two OFDM symbols used as a PDCCH in the MBSFN subframe, and this CRS is not for an MBSFN. A CP of the CRS transmitted in the first two OFDM symbols used as the PDCCH in the MBSFN subframe (that is, whether the CRS uses a normal CP or an extended CP) follows a CP applied to a normal subframe, that is, a subframe which is not an MBSFN subframe. For example, when a normal subframe 511 uses a normal CP, a CRS according to the normal CP is also used in the first two OFDM symbols 512 of the MBSFN subframe.

Meanwhile, a subframe to be configured as an MBSFN subframe is designated by FDD and TDD, and a bitmap is used to indicate whether a subframe is an MBSFN subframe. That is, when a bit corresponding to a specific subframe in a bitmap is 1, it is indicated that the specific subframe is configured as an MBSFN subframe.

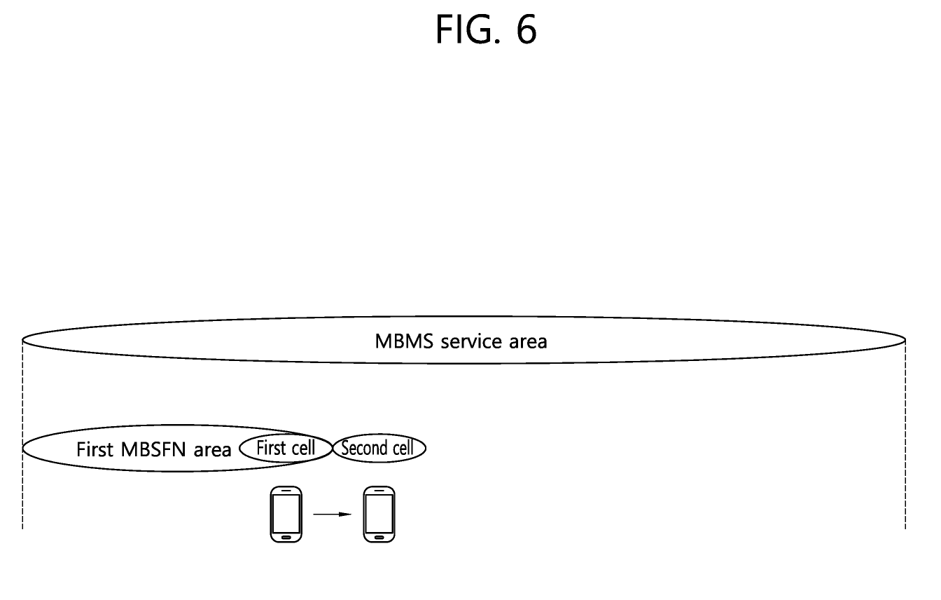

FIG. 6 illustrates an example in which a UE moves from an MBSFN area to a different MBSFN area or a non-MBSFN area. FIG. 6 illustrates a delay caused by the movement of the UE to the other MBSFN area or non-MB SFN area.

1) Operation 1: The UE may access a first cell in a first MBSFN area and may receive an interest MBSFN service.

2) Operation 2: As the UE moves from the first cell to a second cell, the UE may be handed over to the second cell having an intra-frequency that is out of the first MBSFN area. The UE may read SIB13 (including information necessary to receive an MBMS) of the second cell, thus recognizing that the second cell is a cell out of the first MBSFN area.

3) Operation 3: The UE may read SIB15 (including information necessary to receive an MBMS of an adjacent carrier frequency) of the second cell, thus recognizing that there is no suitable frequency to continuously receive an interest MBMS service.

4) Operation 4: The UE may trigger unicast bearer configuration through application level signaling in order to continuously receive group communication through unicast.

The UE may always receive service interruption on the edge of the MBSFN area after operation 1 depending on MBSFN signal quality and UE capability. Table 2 illustrates service interruption time due to a movement from the MBSFN area to the different MBSFN area or non-MBBSFN area.

TABLE 2

| Component | Time | Comment |
|---|---|---|
| Delay in MIB reading in second cell | 40 ms | |
| Delay in SIB1 reading in second cell | 80 ms | |
| Delay in SIB2, SIB13, and SIB15 | 160 ms | Assuming that SIB13/15 have a |
| reading in second cell | | scheduling period of 320 ms, and SIB2 |
| | | has a short scheduling period. |
| Delay in transition from RRC_IDLE | 80 ms | TR 36.912 Section B.1.1.1 |
| state to RRC_CONNECTED state | | |
| Dedicated bearer for establishing VoIP | 115 ms | TR 36.868 Section 5.1.1.1 |
| Total delay | 475 ms | |

As illustrated, as the UE moves, a service interruption time of about 500 ms occurs. The existing MBMS focuses on a video broadcasting service and thus has no significant problem with delay time, but may be inappropriate for an interruption-sensitive service, such as group communication. Thus, the present invention proposes a method for minimizing delay time in an MBMS service.

Hereinafter, a UE operation in RRC_CONNECTED MODE proposed in the present invention is described.

When at least one of the following conditions is satisfied, a UE in RRC_CONNECTED MODE, which receives an MBMS service from an MBSFN area, may request unicast/MBMS transmission of the MBMS service from a network in order to continuously receive the MBMS service through a unicast/MBMS bearer.

1) Condition 1: The UE may receive an RRCConnectionReconfiguration message including mobilityControlInfo from a PCell. A target PCell indicated by targetPhysCellId is not included in an MBMS cell list corresponding to an interest MBMS service.
Preferably, after a handover through a ULlnformationTransfer message, the UE may request unicast/MBMS transmission of the interest MBMS service from the target PCell.

2) Condition 2: The UE may receive a RRCConnectionReconfiguration message including mobilityControlInfo. A downlink frequency of a target PCell, which is indicated by carrierFreq, is not for providing an interest MBMS service.

3) Condition 3: A measurement report is triggered (for example, by a specified event, such as A3), and a target cell triggering the measurement report may not be included in an MBMS cell list corresponding to an interest MBMS service.
Preferably, when receiving a measurement report according to this condition, a BS may indicate to an MCE or EPC (such as MME or GCSE AS) that the target cell needs to configure the MBMS service (or the UE may move to the target cell for the MBMS service).
Preferably, when the measurement report is triggered by a specified event, the UE may request only unicast/MBMS transmission and the specified event may be configured by the network.
Preferably, before a handover through a ULlnformationTransfer message, the UE may request unicast/MBMS transmission of the interest MBMS service from a source PCell.

Hereinafter, a UE operation in RRC_IDLE MODE proposed in the present invention is described.

When at least one of the following conditions is satisfied, a UE in RRC_IDLE MODE, which receives an MBMS service from an MBSFN area, may request a unicast/MBMS bearer configuration of the MBMS service from a network in order to continuously receive the MBMS service through a unicast/MBMS bearer.

1) Condition 1: The UE selects a new serving cell through a cell selection procedure or cell reselection procedure, and the new serving cell is not included in an MBMS cell list corresponding to the MBMS service.

2) Condition 2: A measurement result of a neighboring cell is better than a threshold, and the neighboring cell is not included in an MBMS cell list corresponding to the MBMS service.
Preferably, the unicast/MBMS bearer configuration may be an NAS message or RRC message indicating the MBMS service.

Hereinafter, an MBMS cell list proposed in the present invention is described.

A UE may receive an MBMS cell list from a network.
Preferably, the MBMS cell list may be signaled per MBSFN area, service area, service (for example, MBMS service or GC service), or frequency.
Preferably, the MBMS cell list may be broadcast through system information, a USD, or dedicated signaling.

The present invention may be applied only to a specified type of MBMS service sensitive to interruption (MBMS for group communication or MBMS for public safety).

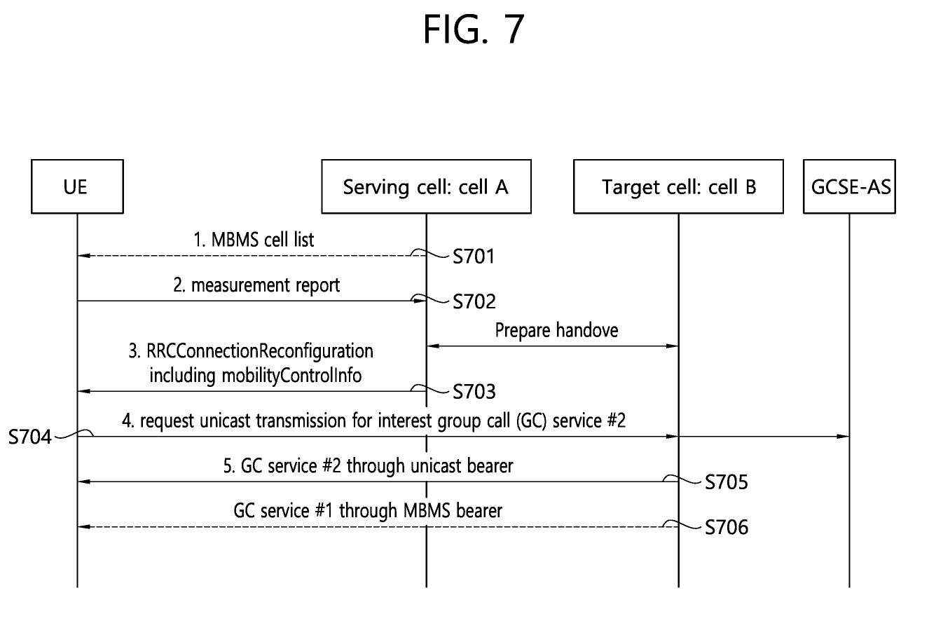

FIG. 7 illustrates an example of a UE operation in RRC_CONNECTED MODE according to one embodiment of the present invention.

First, a UE receives two group call (GC) services (that is, GC service #1 and #2) through an MBMS bearer, wherein GC service #1 and #2 may be provided respectively by MBSFN area #1 and #2 (if GC service #1 and #2 are provided by an MBMS cell list, the UE may indicate to a network that the UE is interested in GC service #1 and #2).

1) The UE may receive an MBMS cell list from a serving cell through system information (S701). Cell A is included in an MBMS cell list corresponding to MBSFN area #1 (or service area #1) and is included in an MBMS cell list corresponding to MBSFN area #2 (or service area #2). Cell B is included in the MBMS cell list corresponding to MBSFN area #1 (or service area #1) but is not included in the MBMS cell list corresponding to MBSFN area #2 (or service area #2).

(Alternatively, the UE may receive an SAI through the system information. However, one service area may correspond to one MBMS cell list mapped to one SAI. In this case, the UE may receive mapping between an SAI and an MBMS cell list through an USD or another signaling. The UE may identify the MBMS cell list from the received SAI based on received mapping.)

2) The UE may transmit a measurement report to the serving cell (S702). (In addition, when receiving the measurement report (for example, by a specified event, such as A3), a BS may indicate to an MCE or EPC (such as MME or GCSE AS) that a target cell needs to configure an MBMS service, or the UE may move to the target cell for an MBMS service). This indication may trigger the network so that the target cell prepares an MBMS service through a unicast bearer or MBMS bearer.)

3) The UE may receive a handover command message from the serving cell (S703). The handover target cell indicated by the serving cell is cell B, and cell B is not included in the MBMS cell list corresponding to MBSFN area #2.

4) The UE may request unicast transmission from the network in order to continuously receive GC service #2 through a unicast bearer (S704).

5) The UE may receive GC service #2 through the unicast bearer (S705) but may receive GC service #1 still through the MBMS bearer (S706).

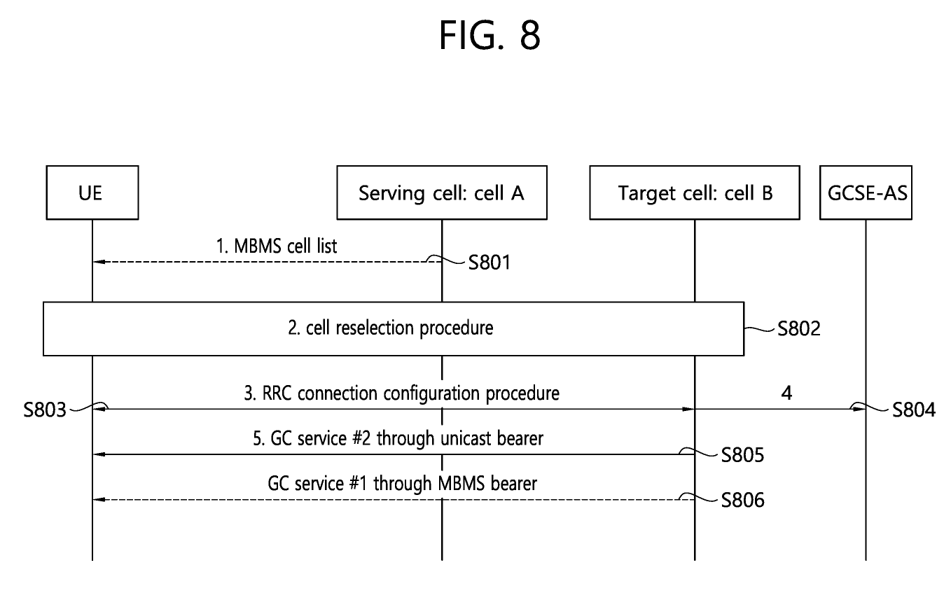

FIG. 8 illustrates an example of a UE operation in RRC_IDLE MODE according to one embodiment of the present invention.

First, a UE receives two group call (GC) services (that is, GC service #1 and #2) through an MBMS bearer, wherein GC service #1 and #2 may be provided respectively by MBSFN area #1 and #2.

1) The UE may receive an MBMS cell list from a serving cell through system information (S801). Cell A is included in an MBMS cell list corresponding to MBSFN area #1 (or service area #1) and is included in an MBMS cell list corresponding to MBSFN area #2 (or service area #2). Cell B is included in the MBMS cell list corresponding to MBSFN area #1 (or service area #1) but is not included in the MBMS cell list corresponding to MBSFN area #2 (or service area #2).

(Alternatively, the UE may receive an SAI through the system information. However, one service area may correspond to one MBMS cell list mapped to one SAI. In this case, the UE may receive mapping between an SAI and an MBMS cell list through an USD or another signaling. The UE may identify the MBMS cell list from the received SAI based on received mapping.)

2) The UE may select cell B as a new serving cell (S802).

3) Cell B is not included in the MBMS cell list corresponding to MBSFN area #2. Thus, the UE may request a unicast bearer configuration from a network in order to continuously receive GC service #2 through a unicast bearer (S803). A unicast/MBMS bearer configuration may be an NAS message or RRC message indicating an MBMS service.

4) If the unicast/MBMS bearer configuration is an NAS message such as a service request, an MME may receive a message from the UE. The request may be transmitted to a group communication system enablers application server (GCSE-AS) capable of configuring a unicast/MBMS bearer of GC service #2 (S804).

5) In configuration by a BS, the UE may establish a unicast bearer and may receive GC service #2 through the unicast bearer (S805). However, the UE may receive GC service #1 still through the MBMS bearer (S806). (Alternatively, the network may configure an MBMS bearer, instead of a unicast bearer for GC service #2, in the target cell (cell B).)

The present invention may minimize delay time caused by the movement of a UE from an MBSFN area to a non-MBSFN area, thereby stably providing an MBMS service. Further, for clear understanding, a UE operation has been described with reference to group communication as a type of MBMS service, the technical idea of the present invention is not limited to group communication but may be applied to all MBMS services.

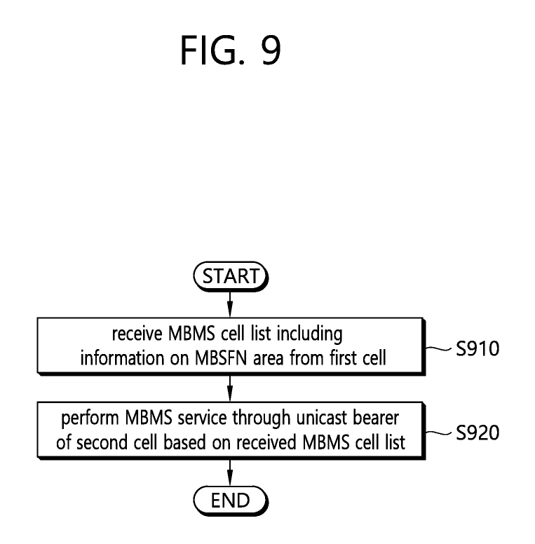

FIG. 9 is a block diagram illustrating a method for maintaining continuity of an MBMS service in an MBSFN service boundary area according to one embodiment of the present invention.

Referring to FIG. 9, a UE may receive an MBMS cell list including information on an MBSFN area from a first cell (S910). The first cell is a cell in which the UE provides an MBMS service through an MBMS bearer. The UE may perform the MBMS service with UEs in the first cell through a unicast bearer of a second cell based on the received MBMS cell list (S920). The second cell is not included in the MBMS cell list. The UE receives the MBMS cell list in advance from the first cell and thus may know that the second cell is not included in the MBMS cell list of interest. Further, although the UE with mobility moves to the second cell, the UE may perform the MBMS service with UEs in the first cell through a unicast bearer, thus reducing delay time of the MBMS service.

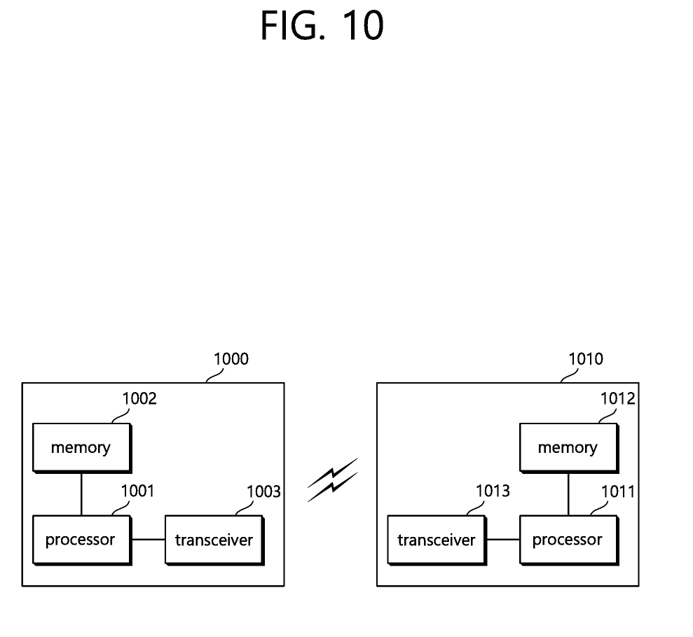

FIG. 10 is a block diagram illustrating a wireless communication system according to the embodiment of the present invention.

A BS 1000 includes a processor 1001, a memory 1002 and a transceiver 1003. The memory 1002 is connected to the processor 1001, and stores various information for driving the processor 1001. The transceiver 1003 is connected to the processor 1001, and transmits and/or receives radio signals. The processor 1001 implements proposed functions, processes and/or methods. In the above embodiment, an operation of the base station may be implemented by the processor 1001.

A UE 1010 includes a processor 1011, a memory 1012 and a transceiver 1013. The memory 1012 is connected to the processor 1011, and stores various information for driving the processor 1011. The transceiver 1013 is connected to the processor 1011, and transmits and/or receives radio signals. The processor 1011 implements proposed functions, processes and/or methods. In the above embodiment, an operation of the base station may be implemented by the processor 1001.

The processor may include an application-specific integrated circuit (ASIC), a separate chipset, a logic circuit, and/or a data processing unit. The memory 1020 may include a read-only memory (ROM), a random access memory (RAM), a flash memory, a memory card, a storage medium, and/or other equivalent storage devices. The transceiver 1030 may include a base-band circuit for processing a wireless signal. When the embodiment is implemented in software, the aforementioned methods can be implemented with a module (i.e., process, function, etc.) for performing the aforementioned functions. The module may be stored in the memory 1020 and may be performed by the processor 1010. The memory 1020 may be located inside or outside the processor 1010, and may be coupled to the processor 1010 by using various well-known means.

Various methods based on the present specification have been described by referring to drawings and reference numerals given in the drawings on the basis of the aforementioned examples. Although each method describes multiple steps or blocks in a specific order for convenience of explanation, the invention disclosed in the claims is not limited to the order of the steps or blocks, and each step or block can be implemented in a different order, or can be performed simultaneously with other steps or blocks. In addition, those ordinarily skilled in the art can know that the invention is not limited to each of the steps or blocks, and at least one different step can be added or deleted without departing from the scope and spirit of the invention.

The aforementioned embodiment includes various examples. It should be noted that those ordinarily skilled in the art know that all possible combinations of examples cannot be explained, and also know that various combinations can be derived from the technique of the present specification. Therefore, the protection scope of the invention should be determined by combining various examples described in the detailed explanation, without departing from the scope of the following claims.

What is claimed is:

1. A method for maintaining continuity of a Multimedia Broadcast/Multicast Service (MBMS) service, by a user equipment (UE), in a multicast/broadcast single frequency network (MBSFN) service boundary area, the method comprising:
receiving, from a first cell, an MBMS cell list comprising information on a cell providing the MBMS service; and
performing the MBMS service via a unicast bearer of a second cell based on the received the MBMS cell list, if the second cell does not provide the MBMS service,
wherein the first cell is a cell in which the UE performs the MBMS service via an MBMS bearer.

2. The method of claim 1, wherein the MBMS cell list is signaled per MBSFN area, service area, service, or frequency.

3. The method of claim 1, wherein the MBMS cell list is received through at least one of system information, a user service description (USD), and dedicated signaling.

4. The method of claim 1, wherein the second cell has a different MB SFN area providing the MBMS service than the first cell.

5. The method of claim 1, wherein the MBMS cell list further comprises frequency information on the cell providing the MBMS service.

6. The method of claim 1, wherein a frequency of the second cell is not comprised in the MBMS cell list.

7. The method of claim 1, wherein an identity (ID) of the second cell is not comprised in the MBMS cell list.

8. The method of claim 1, further comprising receiving a handover command message from the first cell, performing a handover to the second cell, and requesting unicast transmission from a network, when the UE is in an RRC connected state and moves to the second cell.

9. The method of claim 8, wherein the second cell is a cell triggering a measurement report.

10. The method of claim 1, further comprising selecting the second cell as a new serving cell and requesting configuration of the unicast bearer from the second cell, when the UE is an RRC idle state.

11. The method of claim 10, further comprising requesting an RRC connection from the second cell.

12. The method of claim 10, wherein a quality measurement result of the second cell is a predetermined threshold or higher.

13. The method of claim 10, wherein the configuration of the unicast bearer is an NAS message or RRC message.

14. A user equipment (UE) for maintaining continuity of a Multimedia Broadcast/Multicast Service (MBMS) service in a multicast/broadcast single frequency network (MBSFN) service boundary area, the UE comprising:
a memory;
a transceiver; and
a processor to connect the memory and the transceiver,
wherein the processor is configured to:
control the transceiver to receive, from a first cell, an MBMS cell list comprising information on a cell providing the MBMS service; and
perform the MBMS service via a unicast bearer of a second cell based on the received the MBMS cell list, if the second cell does not provide the MBMS service, and
the first cell is a cell in which the UE performs the MBMS service via an MBMS bearer.

15. The UE of claim 14, wherein an identity (ID) of the second cell is not comprised in the MBMS cell list.
